(19) United States
(12) Patent Application Publication
(10) Pub. No.: US 2004/0255650 A1
(43) Pub. Date: Dec. 23, 2004

(54) Capillary rise technique for the assessment of the wettability of particulate surfaces

(75) Inventors: Brij M. Moudgil, Gainesville, FL (US); Scott C. Brown, Gainesville, FL (US); Roberto C. Oliveira, Rio De Janeiro (BR)

Correspondence Address: AKERMAN SENTERFITT, P.O. BOX 3188, WEST PALM BEACH, FL, 33402-3188, US

(73) Assignee: University of Florida, Gainesville, FL

(21) Appl. No.: 10/786,991

(22) Filed: Feb. 25, 2004

Related U.S. Application Data
(60) Provisional application No. 60/450,025, filed on Feb. 25, 2003.

(51) Int. Cl. G01N 13/00

(52) U.S. Cl. 73/64.55

(57) ABSTRACT

A method and system for determining the wettability of particulate surfaces. In particular, the method for determining the wettability of particulate surface includes the steps of inserting a test device having the particulate surface into a test liquid to form a liquid meniscus; measuring the liquid meniscus to generate a liquid meniscus measurement; and calculating the wettability of the particulate surface using the liquid meniscus measurement. The system for determining the wettability of particulate surface includes a test device having the particulate surface; a test liquid; and a measurement device.

### CROSS-REFERENCE TO RELATED APPLICATIONS

This application claims priority to U.S. Provisional patent application No. 60/450,025, filed Feb. 25, 2003.

### STATEMENT REGARDING FEDERALLY SPONSORED RESEARCH OR DEVELOPMENT

Not applicable.

### FIELD OF THE INVENTION

The present invention is directed to a method and system for determining the wettability of particulate surfaces.

### BACKGROUND OF THE INVENTION

A number of techniques currently exist for the determination of the wetting properties of particle surfaces. However, these techniques have one or more of the following limitations: the process only provides relative results; the process requires a test liquid other than the liquid phase used in the process or application in which the particles are involved; the process requires particles of well-defined geometries and surfaces; the process is tedious and time-consuming; the process has low precision; the process involves significant capital investment for the required instrumentation; the process is limited to micron-sized and larger particles; the process is limited to either hydrophilic or hydrophobic particulates; and/or the process deforms the particulate surface.

For example, the most common particle wettability methods—the capillary penetration (Washburn, 1921; Bartell and Osterhof, 1927) and the tablet formation techniques (Zografi and Tam, 1976)—attempt to constrain an ensemble of particles into either a porous or a solid-like structure, respectively, to which the test liquid is applied. The capillary penetration methods involve packing the powder of interest into a porous plug that is partially immersed into a test liquid of known surface tension and density. The capillary rise or depression of the test liquid is monitored and correlated to an average particle contact angle through a variation of the Laplace equation by modeling the packed bed of particles as a bundle of capillaries. Significant artifacts and a lack of reproducibility occurs due to ill-defined and varying capillary structures that are formed by this technique along with further complications that arise from the mobilization and the reorganization of the particles with the advancing and the receding liquid fronts. The tablet formation technique avoids these issues by consolidating the powder of interest into a tablet onto which the contact angle is measured via a macroscopic flat plate routine— usually the sessile drop or captive bubble methods. However, equally severe errors may arise since the morphology, roughness, and chemical composition of the particles surfaces are often modified during tablet preparation, causing these surfaces to be non-representative of the primary particles. In both of these methods major errors arise from inadequacies of the multi-particle immobilization process.

Due to the inadequacies of the direct techniques above, a number of indirect methods have been devised. The film flotation technique (Fuerstenau and Williams, 1987; Marmur et. al, 1986) has been extensively used to rank particulate products by their relative hydrophillicities. In this method a known mass of particles are spread at the liquid-vapor interface and the number or the mass of particles that becomes engulfed by the bulk liquid as the surface tension is decreased is recorded. The particle's wettability is ranked either by critical surface tension (the surface tension at which the largest mass of particles sinks into the liquid phase) or by the maximum surface tension at which the complete wetting of all particles occurs (no particles present at the interface). Normally water is titrated with either methanol or ethanol to achieve the desired surface tension intervals. The results are frequently reported in terms of the percent titrant concentration required for the critical or necessary surface tension. Although this method is reproducible the values are only relative in nature and the method is limited to particles with apparent solid-vapor surface tensions in the approximate range of 20-72 mN/m.

The sedimentation volume technique (Vargha-Butler et al., 1985; Omenyi et. al, 1981) employs a similar approach. In this case the state of aggregation of particles dispersed in a series of solutions is investigated. The method assumes purely van der Waals forces between identical particles in which the interactions are governed by the free energy of cohesion. When the sedimentation volume is at an extremum the particle's surface tension is assumed equal to that of the suspending medium. Theoretically this method is only valid for pure liquids; however, in practice liquid mixtures are used to access a larger range of surface tensions. The results from this technique may be quantitative; however, artifacts arising from non van der Waal interactions or the presence of unlike particles (particle mixtures) may give misleading results.

Oil and water vapor absorption/adsorption studies have also been employed to indirectly determine particle wetting characteristics (Solomon and Hawthorne, 1991; Buckton et al., 1986). In these measurements the particles are ranked based on their ability to absorb/adsorb a nonpolar organic compound or water vapor, respectively, on a per mass basis. The extent at which this occurs largely depends on the particles size, morphology and internal pore structure in addition to their surface energetics. Therefore the relative wettability of these particles may only be found after additional tests are preformed.

Similarly, heat of immersion studies (Good and Girifalco, 1958) have also been used to indirectly measure particle contact angles. In these methods the heat evolved per square centimeter of powder immersed in a liquid is directly measured and theoretically related to the average particle contact angle. The method requires that the specific surface area of the powder is known, and no other sources of enthalpy must be present (e.g. contributions from the partial dissolution of the particles). Yet, due to the temperature dependence of contact angles, heat of immersion data will normally only provide relative and semi quantitative information (Li and Neumann, 1996). In general, indirect techniques require a series of time-consuming tests to achieve meaningful data and the technique used typically varies with industry and with particle application.

Recently, a number of advanced techniques for directly measuring particle contact angles through the incorporation of devices such as Langmuir troughs (Clint and Taylor, 1992; Clint and Quirke, 1993), Sheludko Cells (Hadjiiski et al., 1996), and atomic force microscopes (Ducker et al., 1994) have been developed. Surface pressure versus trough area isotherms generated by Langmuir troughs have been used to determine advancing and receding contact angle on mono-dispersed, well-defined powders distributed at the liquid-vapor interface. In these experiments the trough area is incrementally decreased, which subsequently causes the surface pressure to increase due to the closer packing of the particulates at the interface. At a critical trough area the layer of floating particles becomes close-packed and further reductions in the trough area result in the particles (one-by-one) moving out into either the vapor or liquid phase. By calculating the free energy required to squeeze out these particles (upon an assumed close-packed structure) the advancing or the receding particle contact angle is found depending on whether the particles move into the liquid or vapor phases, respectively. Unfortunately, this technique is limited to particulate systems of well-defined geometries and size distributions for accurate results. By injecting dilute dispersions of particles into a Scheludko cell and subsequently removing part of the liquid in order to trap the particles in a liquid film, Hadjiiski and coworkers (1996) have measured contact angles on single particles. This film trapping method uses the interference patterns formed from monochromatic reflected light to numerically reconstruct the meniscus formed around a particle—from which the contact angle is derived. However, since this is an optical method, it is limited to micron-sized particles of well-defined geometries.

The atomic force microscope (AFM) has also become a useful tool for measuring the contact angle on single particles. Through the use of an inert adhesive, a representative particle is immobilized onto the tip of an AFM cantilever to form a colloid probe. This colloidal probe is then used in a liquid cell to interact with a millimeter-sized confined bubble. The equilibrium distance that the particle moves into the bubble is used to geometrically calculate the receding angle; whereas the advancing angle is calculated from the maximum force required to pull the particle out of the bubble and back into the liquid phase. As with the film trapping technique, micron-sized particles of well-defined geometries are required also for these experiments. Unfortunately, these advanced methods are tedious, limited to particles of well-known geometries and must be performed in more-or-less ideal environments for adequate precision—therefore they have not been widely adopted for industrial use.

Accordingly, what is needed is a new system and method that overcomes the deficiencies of these prior art systems and methods. The present invention provides a system and method that are a simple, precise, and relatively quick technique to obtain semi-quantitive to quantitative data of the wettability (dynamic, static, wetting and dewetting) of particulate surfaces with liquids of choice without the limitations of the prior art.

### SUMMARY OF THE INVENTION

The invention provides a system and method for the quick and precise measurement of the dynamic and static wettability of particles. The present invention provides a system that includes the coating of an inert cylinder—or a portion of a cylinder—with a layer of a material having a tacky or slightly tacky characteristic, and subsequently applying a layer of the particles onto the adhesive layer. This device may then be used by bringing the device into contact with a liquid of interest. Then, measurements are taken and correlated to an apparent contact angle through a solution of the Laplace equation (also known as the Equation of Capillarity). As a result, the wettability of the particles may be quickly determined using fewer steps than prior art systems and methods. Also, in alternative embodiments, the substrate may have a non-cylindrical shape, such as a hexagonal, square, or elliptical cross-section.

In particular, the present invention provides a method for determining the wettability of particulate surface including the steps of inserting a test device having the particulate surface into a test liquid to form a liquid meniscus; measuring the liquid meniscus to generate a liquid meniscus measurement; and calculating the wettability of the particulate surface using the liquid meniscus measurement.

The present invention also provides a system for determining the wettability of particulate surface, wherein the system includes a test device having the particulate surface; a test liquid; and a measurement device.

The present invention allows for a quick and precise measurement of the dynamic and static wettability of fine particles directly into the solution into which they will be applied. It may also be scaled to accommodate different types of applications.

### BRIEF DESCRIPTION OF THE DRAWINGS

Other objects, features and advantages of the will become apparent upon reading the following detailed description, while referring to the attached drawings, in which:

FIG. 1 is a perspective view of one embodiment of a testing device useful in the present invention.

FIG. 2 is an illustration of the test procedure for measuring external capillary height to determine particulate wettability.

FIG. 3 is an illustration of the test procedure for measuring the external meniscus to determine particulate wettability.

FIG. 4 shows one embodiment of en experimental system that may be used to perform an optical analysis to determine particulate wettability.

FIG. 5 is a graphical representation of dynamic contact angles measured on rods coated with 16 nm Aerosil R-972 silanated silica particles partially immersed in sodium dodecyl sulfate (SDS)/deionized (DI) water solutions (pH 5.6).

### DETAILED DESCRIPTION OF THE INVENTION

The present invention is more particularly described in the following examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of’ and “consisting essentially of.”

The present invention provides a method for determining the wettability of particulate surface that improves upon prior art technologies and a system useful for carrying out the method. The present invention may be used to quickly and accurately determine particle wettability and may be used in portable particle wettability devices and to take particle wettability measurements for process and quality control. The present invention also increase the efficiency of particulate-based processes through quicker, more-reliable measurements.

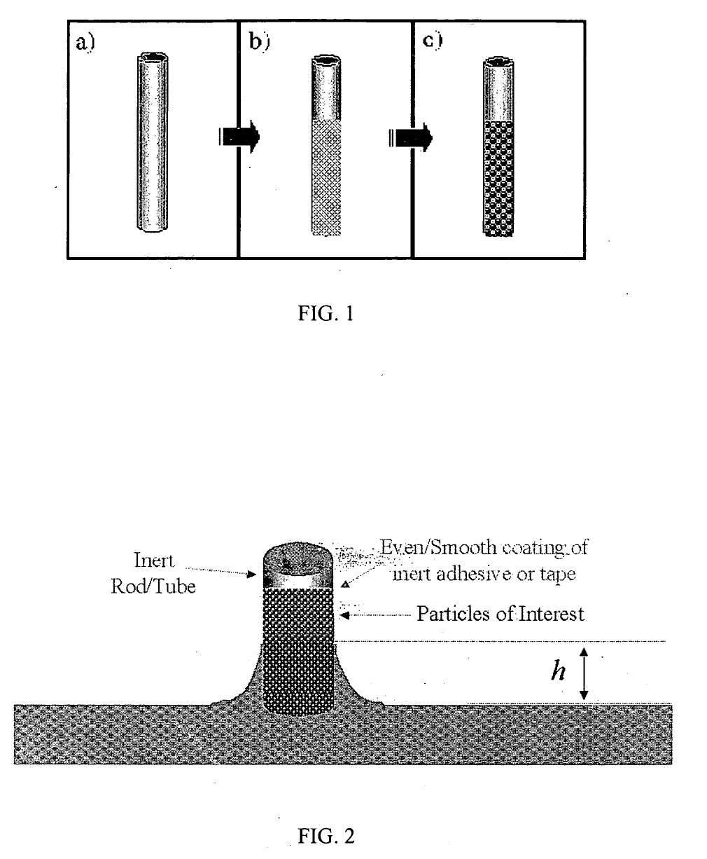

Reference is now made with specific detail to the drawings in which like reference numerals designate like or equivalent elements throughout the several views, and initially to FIG. 1. In one embodiment of the present invention, the present invention provides a device 10 that is capable of determining the wettability of a particulate material. The device 10 includes a substrate 12 that is inert with respect to the test liquid and particles. The device 10 also includes a thin layer of adhesive material 14 on at least a portion of the device 10. The device also includes a layer of particles 16 adhered to the adhesive 14.

As shown in FIG. 1, the substrate 12 is a rod or tube having a circular cross-section. The use of substrates having a cylindrical, or partially cylindrical surfaces, results in test devices that generally provide one or more of the following benefits: increased precision, less user bias, simpler to use, less equipment required, experiment timescale, and potential application in industrial environments. However, it is to be understood that in alternative embodiments, the substrate may have other geometrical cross-sections, including, but not limited to, a square, a triangle or a hexagon.

Additionally, the substrate is formed from a material that is inert with respect to the particles being tested and the test liquid. Materials that are useful in forming the substrates may include, but are not limited to, glass, wood and a metal. If a metal is used, the metal may be a pure metal or an alloy.

The adhesive 14 used on the device 10 may be any material that is capable of adhering to and substantially retaining the particles 16 to the substrate 12. The adhesive 14 may be applied to the entire surface of the substrate 12 or on only a portion of the substrate 12. Generally, the type of adhesive used is chosen from those that do not react with the test liquid, such that the adhesive would loosen its adhesive properties. Examples of adhesives useful in the present invention include, but are not limited to, rubber cements, mastics, pressure sensitive adhesives, acrylics, vinyl acetates, ethylene vinyl acetates, vinyl acrylics, styrene monomers and copolymers, neoprene latexes, nitrile latexes, styrene-butadiene rubber, natural rubber latexes, two component urethanes and epoxies, moisture cured urethanes, adhesives that have been fortified with terpenes, terpene phenolics, rosen esters and other tackifying additives, or combinations thereof. Alternatively, the adhesive 14 may encompass a tape that is capable of adhering to the substrate 12 as well as substantially retaining the particles 16 to the substrate 12. One example of a tape useful in the present invention would be a two-sided tape having a layer of adhesive material on either side of a middle layer.

The device 10 is formed by applying the adhesive 14 to the substrate 12 and then applying the particles of interest 16 to the adhesive 14. The adhesive 14 may be applied to the substrate 12 using any known method for applying a coating including, but not limited to, spraying, dipping, immersion, rolling, or brushing. The exact method used will be dependent on one or more factors including, but not limited to, the type of substrate, the type and form of adhesive used, the type of particles to be applied and/or the degree of surface area of the substrate to be coated.

Once the adhesive has been applied, the particles 16 are applied to the adhesive 14. The particles 16 are applied to form a substantially uniform coating of the particles 16 on the test device 10. Again, the exact method for applying the particles 16 to the adhesive 14 is not critical and any known method may be used, including, but not limited to, spraying, dipping, rolling, brushing, or immersion. Once the particles 16 have been attached with the adhesive 14, the device 10 may be cured or otherwise treated to further adhere the particles 16 to the adhesive 14. The step of curing may include heating the device to dry the adhesive 14 or may include pressing the particles into the adhesive layer to increase the degree of attachment of the particles to the adhesive layer. If a curing step is used, the exact curing step used may be dependent on one or more factors including, but not limited to, the type and form of adhesive used, the type, form and/or shape of the particles and/or the selected degree of adhesion between the particles and the adhesive layer. Once the particles 16 have been attached, any extra particles are removed, such as by brushing, shaking or blowing, to form the testing device 10.

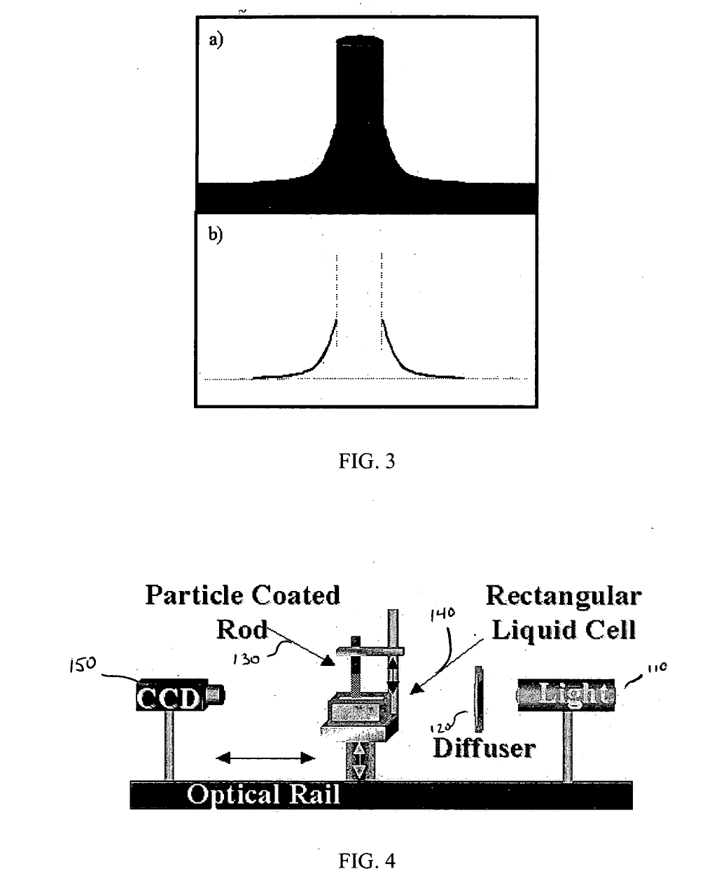

Once the testing device has been formed, it may be used in a method for measuring particulate wettability. In the method, the testing device is brought into contact with the liquid of interest and then either the external capillary height (FIG. 2) or the external meniscus profile (FIG. 3) is optically measured and correlated to an apparent contact angle through a solution of the Laplace equation. Through an analysis of the particle surface coverage area on the cylinder-like device further refinement of the particle contact angles may be performed via existing mathematical relations (e.g. see Cassie 1948, and Wenzel 1936). Since the morphology, chemical composition, and apparent contact angle of the underlying adhesive is known, or can be measured prior to the addition of the particles, contributions from the exposed areas of adhesive (between particles) may be taken into account.

If the external capillary height is the measurement taken, FIG. 2, the testing device is contacted with the test liquid and an optical analysis of the height/depression of the liquid meniscus is performed. The height/depression of the capillary rise is measured with respect to the equilibrium liquid level far from the cylinder and is correlated to apparent contact angle of the particles, thereby indicating the wettability of the coated particles.

If an external meniscus profile is the measurement taken, FIG. 3, the testing device is inserted into the test liquid and an optical analysis of the of the external meniscus is taken. As shown in FIG. 3, the image of the immersed rod and wetting meniscus is shown in a). Then, the optical analysis in b) depicts the extracted meniscus (solid curves), while dotted lines represent the reference points of the rod surface (vertical) and the equilibrium liquid level (horizontal line). From these readings, the contact angle can be determined.

FIG. 4 represents one embodiment of an experimental setup 100 that may be used to obtain the optical image profiles or capillary rise heights to analyze particle contact angles. The instrumentation used to obtain reproducible measurements includes a light source 110 and a diffuser 120, such as frosted glass, etc, that illuminates from behind the particle coated rod 130 as it is dipped, retracted or maintained stationary in a rectangular—or semi-rectangular—transparent liquid cell 140. The process is monitored optically from the opposite side of the rod by an optical analysis device 150 that is capable of determining the meniscus height and/or the extraction of the meniscus profile.

Once the optical image of the particle-coated substrate as it is immersed into the test liquid has been captured with an imaging system, such as the one diagrammed in FIG. 4, the contact angle may then be roughly approximated using the capillary rise equation for a planar surface. This equation analyzes the height of the advancing meniscus with reference to the level of the liquid far from the surface on vertical substrate partially immersed into an infinite liquid well:

$$sin θ = 1 - \frac{( {ρ}_{l} - {ρ}_{v} ) {gh}^{2}}{2 {γ}_{lv}}$$

Where ρₗ represents the density of the liquid phase, ρᵥ represents the density of the vapor phase, g is the gravitational constant, h is the height of the meniscus, Υₗᵥ, is the solid/vapor surface tension, and θ is the apparent contact angle.

The present invention improves upon the existing techniques for particle wettablity to create an improved and novel method to access phenomenological particle contact angles. As previously discussed, the complications that arise in the capillary penetration and tablet formation experiments are primarily due to the inadequacies of the particle immobilization process. These issues may be circumvented by utilizing inert adhesives (meaning they do not appreciably dissolve in the test solution or coat the test particles) to form a substantially uniform coating of particles around a macroscopic body. Hence, the direct measurement of contact angles on the particles of interest by one of the well-developed macroscopic surface contact angle techniques, such as the sessile drop, external capillary rise, or one of the axisymmetric drop shape analysis (ADSA) techniques, may be conducted. The present invention uses the above findings and focuses on its application to systems to provide systems that are easy to use and accurate.

The present invention will now be further described through examples. It is to be understood that these examples are non-limiting and are presented to provide a better understanding of various embodiments of the present invention.

### EXAMPLES

Using an experimental setup as shown in FIG. 4, several preliminary results measurements were made showing that the present invention provides precision measurements while also being easier to use than prior art techniques.

Poly methyl methacrylate (PMMA) beads (˜100 μm) and glass rods were obtained from Polysciences Inc. and Fisher Scientific, respectively. To form irregular glass particles, the glass rods were crushed by mortar and pestle and the resulting powders were classified by sieving. The macroscopic PMMA rod surfaces were created by carefully coating the glass rods with an even layer melt-phase PMMA formed from the beads discussed above. The sodium dodecyl sulfate used in this study was of 99% purity as obtained from the Aldrich Chemical Co, whereas the Aerosil R-972 particles were obtained from Degussa. The acrylate adhesive used in all experiments was obtained from the 3M Corporation. Water used in this study was produced by a Millipore purification system and had an electrical resistance greater than 18 mega ohms and a carbon content of less than 7 parts per billion.

After thorough cleansing, a glass rod was coated with a planar acrylate adhesive to which the test particles were applied. Mechanically instable particulates were subsequently removed by agitation to leave a substantially uniform bed of particulates coated onto the rod.

The image of the particle-coated rod as it is vertically immersed into the test liquid was captured with a simple imaging system as previously discussed (FIG. 4). The contact angle was roughly approximated for these preliminary experiments though the capillary rise equation for a planar surface using the height of the advancing meniscus with reference to the level of the liquid far from the surface on vertical rod partially immersed into an infinite liquid well, also as previously discussed. All measurements were preformed a minimum of three times with the same rod diameter, each with freshly a coated rod surface.

The effect of chemically dissimilar domains and surface topography (roughness) has been studied extensively in the past. Through the works of Cassie (1948) and Wenzel (1936) the basic relations for accounting for chemical inhomogenities and surface roughness have been established. The coated rods in this study may be modeled as chemically and topographically heterogeneous surfaces. Hence, the apparent contact angles measured on these surfaces result from contributions from the particles surfaces, the exposed areas of adhesive, and the liquid or vapor filled voids that may be present at the surface. To test the influence of these contributions on the phenomenological contact angles obtained by this method, measurements were made with both particulate and macroscopic rod surfaces of PMMA and glass, using DI water as the test liquid. In both cases the deviation in the results from the different forms of the same material was within the error of the method—in the range of 1 to 2 degrees as shown in Table 1. From these preliminary experiments it was shown that the apparent contact angles resulting from the present invention were likely almost exclusively represented by the particles of interest.

TABLE 1
The effect of attached particle size on the measured contact angles.
Irregular glass particles of various size fractions using DI
water as the test liquid.

| | Red Surface | Particle-Coated Rod |
|---|---|---|
| Glass | 23.8° ± 1.1° | 23.5° ± 1.8° |
| PMMA | 72.8° ± 0.7° | 72.3° ± 1.1° |
| Acrylate Adhesive | 77.2° ± 0.8° | — |

Next, the apparent contact angles were measured on homogeneous rod surfaces and particle-coated rods. DI water used as the test liquid. The results are shown in Table 2.

TABLE 2
Apparent contact angles as measured on homogeneous rod surfaces
and particle-coated rods.

| Sieve Cut | Apparent |
|---|---|
| (μm) | Contact Angle |
| 106-300 | 23.0° ± 1.9° |
| 300-425 | 23.5° ± 3.25° |
| 425-580 | 27.7° ± 4.9° |

The effect of particle size on the apparent contact angles measured by this technique was also investigated. Different size fractions of crushed glass particulates were immobilized on similar rods and the contact angles with DI water were measured. The resulting data suggests a loss of precision as the particle size is increased from less than 106 μm to approximately half a millimeter in size as shown in Table 2. This phenomena is thought to be attributed to the pinning of the contact line between the large voids that exist between the larger particles in addition to the added difficulty of accurately measuring the height of a thin meniscus on a highly corrugated irregular surface (the surface features on the rod become evident for particles above 300μm). However, in all cases the measured contact angles were essentially the same.

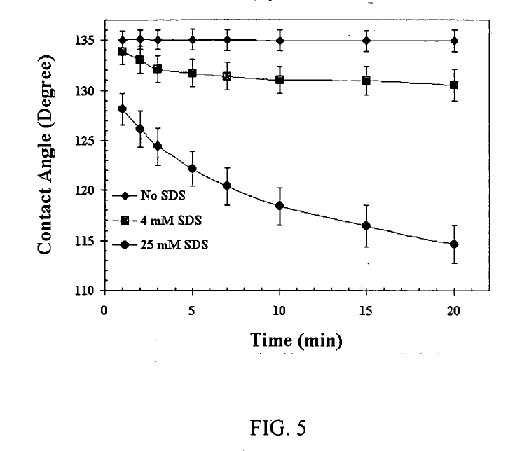

Finally, the application of this technique to dynamic systems with nanosized particles was also established. FIG. 5 depicts the results from dynamic wetting studies on hydrophobic, irregular 16 nm Degussa Aerosil particles exposed to various concentrations of sodium dodecyl sulfate (SDS). In the absence of surfactant the contact angle is shown to be constant with time. This verifies that the acrylate adhesive does not dissolve or migrate to the particle surfaces within the timeframe of the experiments. As the SDS concentration is increased, the starting contact angle (t=1 min) is subsequently decreased as expected. The presence of the surfactant lowers the surface tension of liquid medium and allows for a larger quantity of monomer to hydrophobically adsorb at solid-liquid interface. The results of these studies show that this method is not only effective for dynamic measurements, but also precise and applicable to nanoparticle systems—with the largest error just exceeding ±2° in the absence of sophisticated thermal and vibration isolation systems.

Although the illustrative embodiments of the present disclosure have been described herein with reference to the accompanying drawings and examples, it is to be understood that the disclosure is not limited to those precise embodiments, and various other changes and modifications may be affected therein by one skilled in the art without departing from the scope of spirit of the disclosure. All such changes and modifications are intended to be included within the scope of the disclosure as defined by the appended claims.

What is claimed is:

1. A method for determining the wettability of a particulate surface comprising:
inserting a test device having the particulate surface into a test liquid to form a liquid meniscus;
measuring the liquid meniscus to generate a liquid meniscus measurement; and
calculating the wettability of the particulate surface using the liquid meniscus measurement.

2. The method of claim 1, wherein the step of measuring the liquid meniscus is performed using an optical measuring device.

3. The method of claim 1, wherein the liquid meniscus measurement is a height of the liquid meniscus.

4. The method of claim 1, wherein the liquid meniscus measurement is an external meniscus profile.

5. The method of claim 1, wherein the test device comprises:
a substrate having a surface area;
a layer of adhesive material applied to at least a portion of the surface area of the substrate; and
a layer of particulate material attached to the adhesive material to form the particulate surface of the test device.

6. A system for determining the wettability of particulate surface comprising:
a test device having the particulate surface;
a test liquid; and
a measurement device.

7. The system of claim 6, wherein the measurement device is an optical measuring device.

8. The system of claim 6, wherein the test device comprises:
a substrate having a surface area;
a layer of adhesive material applied to at least a portion of the surface area of the substrate; and
a layer of particulate material attached to the adhesive material to form the particulate surface of the test device.
